(19) United States
(12) Patent Application Publication
(10) Pub. No.: US 2006/0236014 A1
(43) Pub. Date: Oct. 19, 2006

(54) Method and system of coupling a personal digital assistant to a portable computer

(76) Inventors: Memphis-Zhihong Yin, Tomball, TX (US); Paul J. Doczy, Cypress, TX (US); Stacy L. Wolff, Cypress, TX (US); W. Caldwell Crosswy, The Woodlands, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/109,547

(22) Filed: Apr. 19, 2005

(51) Int. Cl. G06F 13/00

(52) U.S. Cl. 710/303

(57) ABSTRACT

A method and system of coupling a personal digital assistant to a portable computer. Some of the illustrative embodiments may be a system comprising a portable computer comprising a docking receptacle on an outer portion of the portable computer, and a personal digital assistant (PDA) (comprising a display device). The docking receptacle couples the PDA to the portable computer, and the PDA reads data from the portable computer to be displayed on the display device of the PDA.

### BACKGROUND

Portable computers, such as laptop and/or notebook computers, have revolutionized access to computing functionality when outside the office environment. Because portable computers provide approximately the same functionality as their desktop brethren, they also may suffer from the same shortcomings, such as the amount of time it takes to boot the computer. For example, a portable computer user may need to access a particular piece of information, such as the time of an appointment. If the user's portable computer is powered-off, it may take several minutes for that portable computer to boot to a state sufficient for the user to retrieve the information.

### BRIEF DESCRIPTION OF THE DRAWINGS

For a detailed description of illustrative embodiments of the invention, reference will now be made to the accompanying drawings in which:

FIG. 1A illustrates a system comprising a portable computer and a personal digital assistant (PDA) in accordance with embodiments of the invention;

FIG. 1B illustrates a different view of the PDA of FIG. 1A;

FIG. 2 illustrates an alternative embodiment of a system comprising a portable computer and PDA;

FIG. 3 illustrates a PDA worn on the wrist of a user in accordance with embodiments of the invention;

FIG. 4 illustrates a PDA worn by a user by way of a lanyard in accordance with embodiments of the invention; and

FIG. 5 illustrates an electrical block diagram of a portable computer and a PDA in accordance with embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure. In addition, one skilled in the art will understand that the following description has broad application, and the discussion of any embodiment is meant only to be exemplary of that embodiment, and not intended to intimate that the scope of the disclosure is limited to that embodiment.

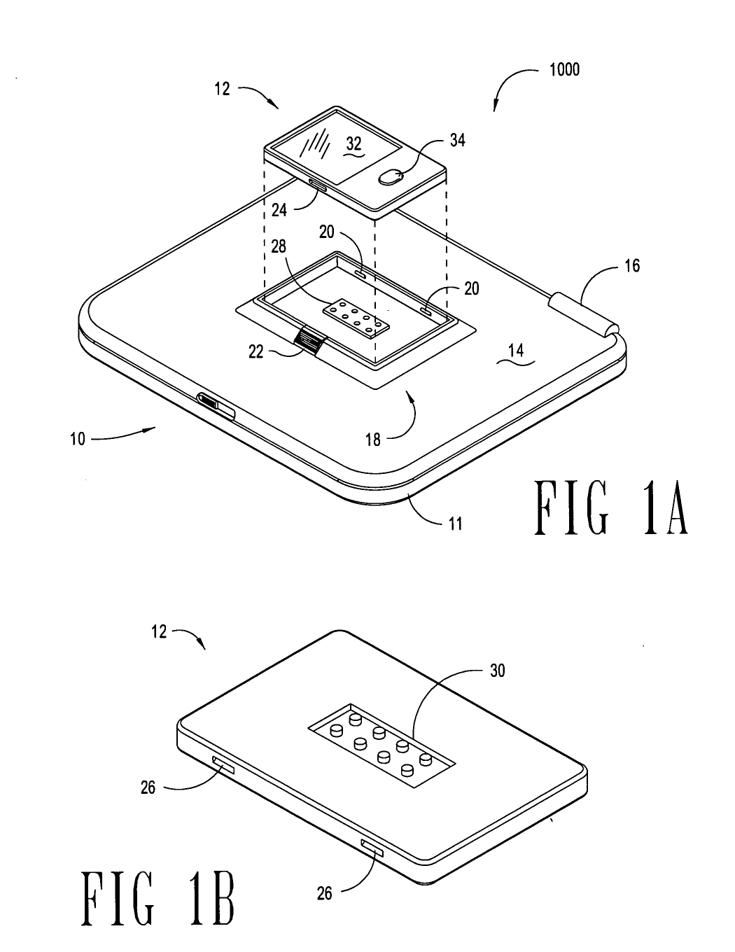

FIG. 1A illustrates a system 1000 comprising a portable computer 10 and a personal digital assistant (PDA) 12. The portable computer 10 comprises a base chassis 11, within which the processor and other electrical functionality is located (discussed more fully below with respect to FIG. 5). The illustrative portable computer 10 also comprises a display chassis 14 hinged to the base chassis 11, such as by hinge 16. The display chassis 14 houses a display device that is visible when the display chassis is rotated about the illustrative hinge 16 to an open position.

A portable computer 10 in accordance with embodiments of the invention further comprises a docking receptacle 18 on an outer portion of the portable computer 10, and as illustrated in FIG. 1A on an outer portion of the display chassis 14. The PDA 12 couples to the portable computer 10 by way of docking receptacle 18. Although any suitable mechanism may be used, in accordance with at least some embodiments the docking receptacle 18 comprises two tabs 20, and a latch 22 that also has a tab (though the tab is not visible in FIG. 1). Correspondingly, the PDA 12 has a slot 24 that mates with the tab on the latch 22. FIG. 1B shows the illustrative PDA 12 in a different perspective view, and in this view the slots 26 that mate with the tabs 20 (of FIG. 1A) are visible. Referring again to FIG. 1A, a user may thus selectively mechanically couple and decouple the PDA 12 to the portable computer 10 by way of the docking receptacle 18.

In the coupled configuration the PDA 12 electrically couples to components of the portable computer 10 by way of a docking connector 28 on the display chassis 14 of the portable computer 10, and by way of a corresponding docking connector 30 (FIG. 1B) on a side of the PDA 12. The electrical connections through the docking connectors 28, 30 will be discussed more fully with respect to FIG. 5.

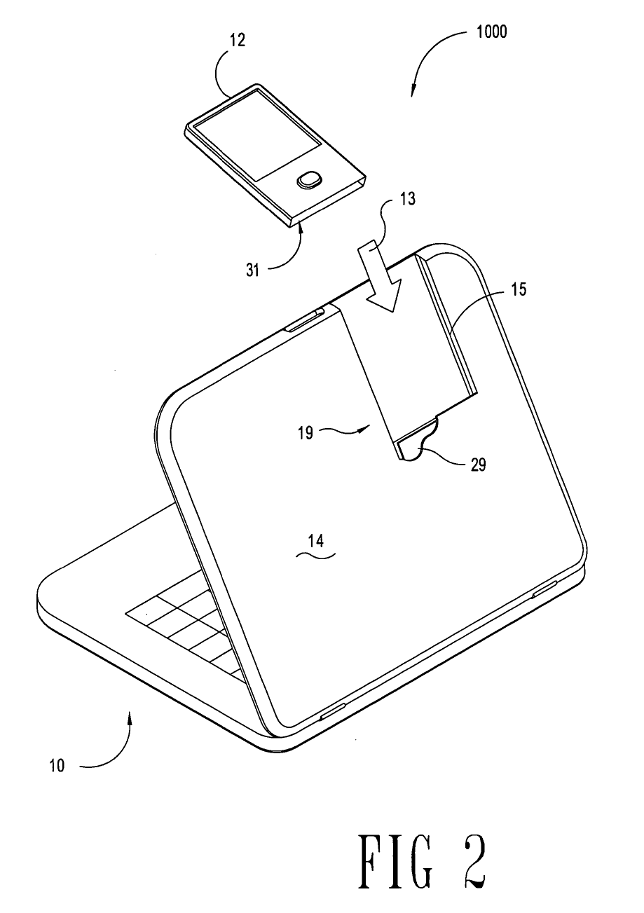

FIG. 2 illustrates alternative embodiments of the system 1000. In illustrative system 1000, the display chassis 14 comprises a docking receptacle 19. In these embodiments the PDA 12 mechanically couples with the docking receptacle 19 by sliding into the receptacle, as indicated by arrow 13, for example by sliding along illustrative rail 15. The PDA in the illustrative case of FIG. 2 electrically couples to the components within the portable computer 10 by way of docking connector 29 and a corresponding docking connector (not specifically shown) in a proximal end 31 of the PDA 12. In the embodiments illustrated in FIG. 2, the slot configuration, as well as configuration of the electrical docking connector 29 may be such as described in the PCI Express™ Wireless Form-Factor (WFF) card electromechanical specification available from the PCI-SIG working group.

In accordance with at least some embodiments of the invention, when the PDA 12 is mechanically and/or electrically coupled (herein referred to as docked) to the portable computer 10, the PDA 12 reads data from the portable computer 10, and in further embodiments the PDA 12 and the portable computer 10 exchange data. For example, while docked the PDA 12 reads the user's task list from the portable computer and/or reads user's calendar from the portable computer. This illustrative data may then be shown on a display device 32 of the PDA 12.

There are several modes of operation of the system 1000 comprising the portable computer 10 and PDA 12. In a first mode of operation, the portable computer 10 is powered-on and operational (even though the display chassis 14 may be closed), and thus the PDA 12 docked thereto exchanges data with the portable computer 10, and displays data on the display device 32. In this mode, a battery and/or charging system of the portable computer 10 may supply sufficient power to run the PDA 12 and/or charge a battery of the PDA.

In a second mode of operation, the PDA 12 is docked to the portable computer 10, but the portable computer 10 is powered-off. In this mode of operation, data previously sent to and/or read by the PDA 12 is displayed on the display device 32 of the PDA 12. Thus, in the illustrative case of task items or calendar events, a user need not boot to the portable computer 10, as the desired information is available by way of the display device 32 of the PDA 12. In this mode of operation, the PDA 12 may still draw operational and charging power from the battery and/or charging system of the portable computer 10.

In yet another mode of operation, the illustrative PDA 12 is mechanically and/or electrically decoupled (herein referred to as undocked or not docked) from the portable computer 10 and used as a standalone device. Prior to undocking the PDA 12 from the portable computer 10, a user may send data to the PDA 12. In this way, needed data, e.g., task items or calendar events, may be viewed by way of the PDA 12. Further, a PDA 12 in accordance with at least some embodiments, has a user interface, such as a mouse control button 34 and/or a digitizer that overlays the display device 32. Using these or other user interfaces, a user may add data to the PDA 12 or change existing data. Upon the next docking of the PDA 12 to the portable computer 10, the additional and/or changed data is communicated to the portable computer 10.

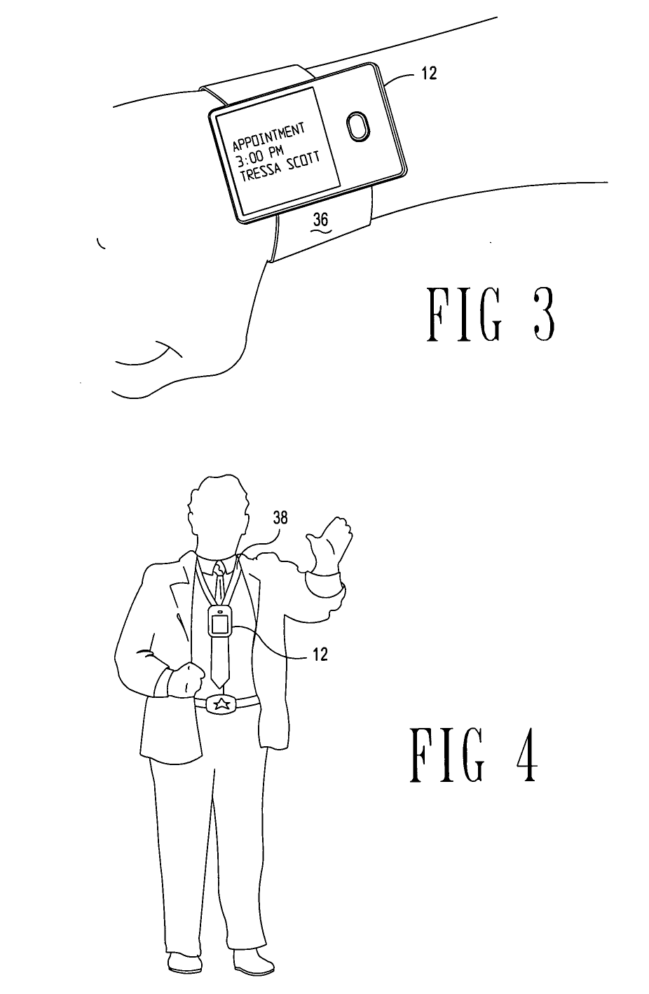

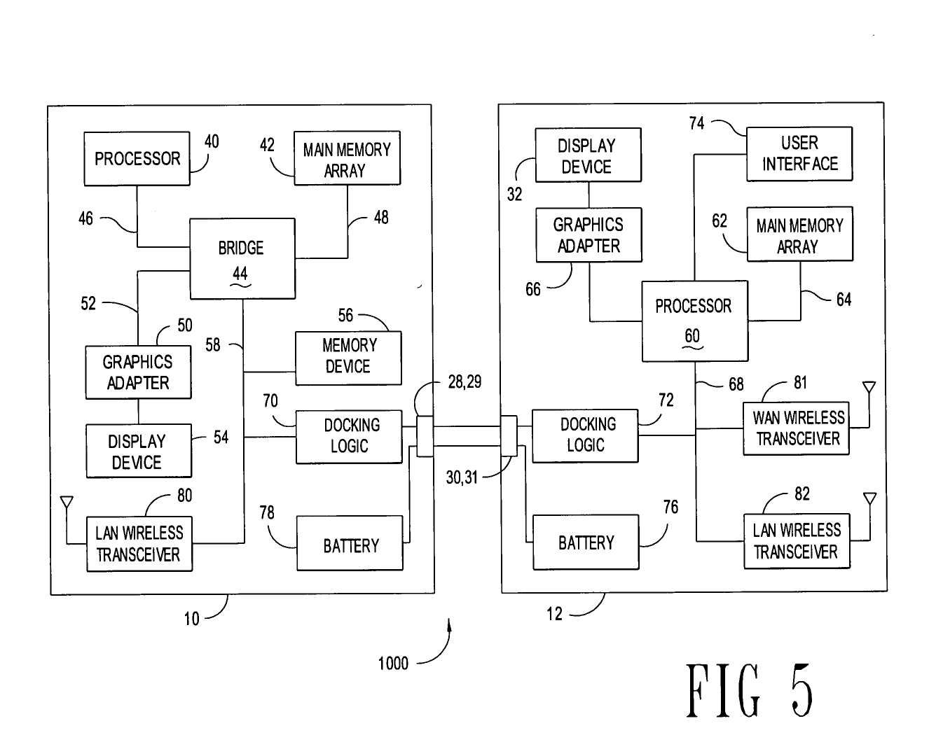

FIG. 3 illustrates that a PDA 12 in accordance with embodiments of the invention, when not docked to the portable computer 10, may be separately carried by the user, such as by attaching the PDA 12 to a wrist band 36. FIG. 4 illustrates alternative embodiments of the invention where the user wears the PDA 12, such as by a lanyard 38 placed around the user's neck.

FIG. 5 illustrates, in block diagram form, the various electrical components of a portable computer 10 and PDA 12 of a system 1000 in accordance with embodiments of the invention. Portable computer 10 comprises a processor 40 coupled to a main memory array 42 by way of a bridge device 44. The processor 40 may be any currently available or after-developed processor. Main memory array 42 may be random access memory (RAM), possibly in the form of a single RAM device, or an array of RAM devices. Bridge device 44 couples to the processor 40 by way of a host bus 46 and to the main memory array 42 by way of a memory bus 48. The bridge device 44 controls the processor's access to the main memory array 42.

Portable computer 10 further comprises a graphics adapter 50 which couples to the processor 40, possibly by way of the bridge device 44. In some embodiments, the graphics adapter 50 couples to the bridge device 44 by way of an Advanced Graphics Port (AGP) bus 52, although any currently available or after-developed bus may be used. The graphics adapter 50 receives graphics primitives generated by a program executing on the processor 40, and translates those graphics primitives into images suitable for display on the display device 54.

Processor 40 also couples to one or more long term storage devices, such as memory device 56, by way of bridge device 44 and an expansion bus 58. In accordance with at least some embodiments of the invention, the memory device 56 may be a disk drive or other type of nonvolatile memory storage, such as a universal serial bus (USB) accessible solid state memory device.

Still referring to FIG. 5, illustrative PDA 12 comprises a processor 60 coupled to a main memory array 62, possibly by way of a memory bus 64. In accordance with at least some embodiments of the invention, processor 60 is a microcontroller, and thus the processor functionality and memory functionality may reside on a single semiconductor die. In accordance with alternative embodiments of the invention, the processor 60 and main memory array 62 are implemented using individual processor and memory components. Processor 60 of the PDA 12 further couples to the display device 32 by way of a graphics adapter 66. Much like the graphics adapter 50 of the portable computer 10, graphics adapter 66 receives graphics primitives generated by a program executing on processor 60, and translates those graphics primitives into images suitable for display on the display device 32.

Illustrative PDA 12 also comprises a user interface 74 coupled to the processor 60. The user interface 74 may take many forms. In some embodiments, the user interface 74 is a full or reduced size keyboard. In alternative embodiments, the user interface 74 is a mouse control device, to enable cursor control, and therefore entry of information, by way of the display device 32. In yet further alternative embodiments, the user interface 74 is a digitizer overlaying the display device 32. In these embodiments, data may be provided to the PDA 12 by a “writing” on the display device 32 overlaid by the illustrative digitizer. In yet further alternative embodiments, the user interface 74 may be a combination of a keyboard, mouse control and/or digitizer devices.

As discussed with respect to FIGS. 1A and 2, in accordance with embodiments of the invention the portable computer 10 electrically couples to the PDA 12 when the PDA 12 is docked. The illustrative drawing of FIG. 5 shows the electrical docking connectors 28, 29, and the mating electrical docking connectors 30, 31. The portable computer 10 comprises a docking logic 70 coupled to the expansion bus 58. Docking logic 70 is responsible for ensuring that in the docking and undocking of the PDA 12 no damage occurs to the electrical components of the portable computer 10, such as by electrical arcing. Likewise, the PDA 12 comprises a docking logic 72, and it too is responsible for ensuring that no damage occurs to the electrical components of the PDA 12 during docking and undocking procedures. In accordance with at least some embodiments of the invention, each of the docking logics 70, 72 provide electrical isolation to their respective expansion buses 58, 68. Once the portable computer 10 and PDA 12 are docked, the docking logics 70, 72 are transparent to communications between the coupled components. In accordance with alternative embodiments, the bus structures as between the expansion bus 58 of the portable computer 10 and the expansion bus 68 of the portable computer 12 may not be directly compatible, and thus one or more of the docking logics 70, 72, in addition to ensuring that no electrical damage occurs, may also perform protocol translation as between the busses.

Still referring FIG. 5, in a mode of operation where the portable computer 10 is docked to the PDA 12 and the portable computer is on and operational, programs executing on the processor 40 of the portable computer 10 may communicate to programs executing on the processor 60 of the PDA 12. Alternatively, programs executing on processor 60 may read data from the memory device 56, and/or may read data, by way of direct memory access techniques, from the main memory array 42. It is by one or more of these communication mechanisms that the PDA 12 and portable computer 10 exchange data, such as the illustrative task items or calendar events.

Still referring to FIG. 5, in the mode of operation where the portable computer 10 is powered-off, yet the PDA 12 is docked to the portable computer 10, the PDA 12 may be operational and display various pieces of data on the display device 32. Moreover, the PDA 12, in accordance with at least some embodiments, may still be able to read data stored within devices of the portable computer 10 in spite of its powered-off condition. For example, in embodiments where the memory device 56 is a solid state nonvolatile memory device, such as a USB-accessible solid-state memory device, the PDA 12 exchanges information with memory device 56 in spite of the fact that other components of the portable computer 10 are powered-off. In this illustrative situation where the memory device 56 is a USB-accessible solid-state memory device, the PDA 12 supplies operational power to the memory device 56 from the PDA's battery 76.

As illustrated in FIG. 5, the PDA 12 thus comprises battery 76. Though the battery 76 is shown to couple only to the electrical connectors 30, 31, inherently the battery 76 couples to and provides power to all devices within the PDA 12. Likewise, portable computer 10 comprises a battery 78, shown to couple only to the electrical connectors 28, 29; however, the battery 78 inherently couples to and provides power to all components of the portable computer 12. FIG. 5 further illustrates that when the portable computer 10 and the PDA 12 are docked, their respective batteries 78 and 76 may, in some embodiments, likewise be coupled. Thus, PDA 12 may draw operational and/or charging power from battery 78 of the portable computer 10.

Still referring to FIG. 5, in accordance with at least some embodiments of the invention, the PDA 12 comprises a local area network (LAN) wireless transceiver 82. In these embodiments, when the PDA 12 is docked to the portable computer 10, the PDA 12 may additionally couple the portable computer 10 to a wireless LAN. The wireless transceiver 82 may take any suitable form, such as an electromagnetic wave communication device that implements communication protocols, such as the Institute of Electrical and Electronics Engineers (IEEE) 802(11) protocols.

In yet further illustrative embodiments, the portable computer 10 may also comprise a LAN wireless transceiver 80, and in these embodiments the portable computer 10 and PDA 12 communicatively couple even when the devices are not electrically coupled by way of the electrical connectors 28, 29 and 30, 31. Thus, the PDA 12 and portable computer 10 may exchange data, e.g., task items and/or calendar events, by way of their respective wireless transceivers 80, 82. In these alternative embodiments the PDA 12 need only be proximate to the portable computer 10 for data to be exchanged.

Still referring to FIG. 5, in yet further alternative embodiments the PDA 12 comprises a wide area network (WAN) wireless transceiver 81, and when the PDA is coupled to the portable computer, the PDA couples the portable computer to the WAN. Alternatively, when the PDA 12 and portable computer 10 are communicating wirelessly by way of their respective LAN wireless transceivers 80, 82, the PDA 12 may still provide WAN connectivity for the portable computer 10. In yet further embodiments, the PDA and portable computer may not be proximate to each other, yet they may be communicatively coupled though a communication relay, such as a satellite. In at least some embodiments, the WAN wireless transceiver 81 is a cellular network wireless transceiver, thus enabling the PDA 12 standing alone, or the PDA 12 and portable computer 10 if communicatively coupled, access to various WAN networks even if both devices are outside the range of their LAN wireless transceiver networks. In embodiments where the WAN wireless transceiver is a cellular network wireless transceiver, the PDA 12 may also implement cellular telephone functionality.

What is claimed is:

1. A system comprising:
portable computer comprising a docking receptacle on an outer portion of the portable computer;
a personal digital assistant (PDA) comprising a display device;
wherein the docking receptacle couples the PDA to the portable computer, and wherein the PDA reads data from the portable computer to be displayed on the display device of the PDA.

2. The system as defined in claim 1 wherein the portable computer further comprises a display chassis comprising a display, and wherein the docking receptacle is on an outer portion of the display chassis of the portable computer.

3. The system as defined in claim 1 further comprising:
wherein the PDA comprises an electrical docking connector and a processor, the processor electrically coupled to the electrical docking connector;
wherein the docking receptacle further comprises an electrical docking connector, and wherein when the PDA is docked, the processor of the PDA electrically couples to the processor of the portable computer through the electrical docking connector.

4. The system as defined in claim 1 further comprising:
wherein. the portable computer comprises a local area network (LAN) wireless transceiver;
wherein the PDA comprises a LAN wireless transceiver; and
wherein the PDA reads data from the portable computer using the LAN wireless transceivers.

5. The system as defined in claim 4 wherein PDA reads data from the portable computer using the wireless transceivers when the PDA is mechanically coupled to the portable computer.

6. The system as defined in claim 4 wherein the PDA reads data from the portable computer when the PDA is proximate to the portable computer.

7. The system as defined in claim 1 further comprising:
wherein the PDA further comprises a wide area network (WAN) wireless transceiver, and wherein the PDA, when coupled to the portable computer, couples the portable computer to the WAN.

8. The system as defined in claim 1 further comprising:
wherein the PDA comprises a wireless transceiver; and
wherein the PDA, when coupled to the portable computer, wirelessly couples the portable computer to a network.

9. The system as defined in claim 8 wherein the PDA, when coupled to the portable computer, wirelessly couples the portable computer to a cellular telephone network.

10. The system as defined in claim 1 wherein the PDA comprises a user interface that accepts data from a user.

11. The system as defined in claim 10 wherein the user interface of the PDA further comprises a keyboard.

12. The system as defined in claim 10 wherein the user interface further comprises a digitizer at least partially overlaying the display of the PDA.

13. The system as defined in claim 1 wherein the PDA reads data from a memory device of the portable computer when the portable computer is powered-off.

14. The system as defined in claim 1 wherein the PDA further comprises a battery, and wherein the portable computer charges the battery of the PDA.

15. A portable computer comprising:
a base chassis comprising a processor;
a display chassis comprising a display hinged to the base chassis; and
a docking receptacle on an outer portion of the display chassis, the docking receptacle mechanically couples a personal digital assistant (PDA) to the portable computer and enables the PDA to read data from the portable computer.

16. The portable computer as defined in claim 15 wherein the docking receptacle further comprises an electrical connector, and wherein when the PDA is mechanically coupled to the portable computer, the electrical connector electrically couples the PDA to the processor.

17. The portable computer as defined in claim 15 wherein the PDA reads data from the portable computer when the portable computer is powered-off.

18. The portable computer as defined in claim 15 further comprising a wireless transceiver coupled to the processor, wherein the portable computer supplies data to the PDA by way of the wireless transceiver.

19. A personal digital assistant (PDA) comprising:
a display device;
a user interface; and
a processor electrically coupled to the display device;
wherein the PDA is configured to mechanically couple to an outer portion of a chassis of a portable computer and to read data from the portable computer, and wherein when not mechanically coupled the PDA is configured to be worn by a user.

20. The PDA as defined in claim 19 wherein the PDA couples the user by at least one of the group: a lanyard; and a wrist band.

21. The PDA as defined in claim 19 further comprising a wireless transceiver, and wherein the PDA reads data from the portable computer using the wireless transceiver.

22. The PDA as defined in claim 21 wherein the PDA reads data using the wireless transceiver when the PDA is mechanically coupled to the portable computer.

23. The PDA as defined in claim 21 wherein the PDA reads data using the wireless transceiver when the PDA is proximate to the portable computer.

24. The PDA as defined in claim 19 further comprising:
a battery coupled to the processor; and
user interface coupled to the processor.

25. The PDA as defined in claim 24 wherein the battery of the PDA is charged by the portable computer when the PDA is mechanically coupled to the portable computer.

26. The PDA as defined in claim 19 further comprising a wireless transceiver, and wherein the PDA couples the portable computer to a network using the wireless transceiver.
